(19) United States
(12) Patent Application Publication
(10) Pub. No.: US 2011/0080015 A1
(43) Pub. Date: Apr. 7, 2011

(54) Pet shelf for vehicles

(76) Inventors: Shelah Spiegel, City of Fountain Valley, CA (US); Roland Clark, City of Huntington Beach, CA (US)

(21) Appl. No.: 12/587,437

(22) Filed: Oct. 6, 2009

(51) Int. Cl. B60R 99/00

(52) U.S. Cl. 296/1.07

(57) ABSTRACT

A pet shelf for use in vehicles includes a pair of angled generally planar members joined in a right angle relationship. One of the angled members defines a support plate which is inserted downwardly within a vehicle door through the gap between the vehicle door and the window. The support plate supports the remaining plate to cover the vehicle door shelf and protect the upholstery material while providing a convenient surface for the dog or other pet to rest upon.

### FIELD OF THE INVENTION

This invention relates generally to vehicles and particularly to apparatus for facilitating the transport of a pet within the vehicle interior.

### BACKGROUND OF THE INVENTION

Many pet owners enjoy taking their pets for rides in a car or other vehicle. As a result, people may often be seen driving a vehicle and having dogs, cats, or other pets within the vehicle. While some pets are transported within vehicles using enclosures or transporters, pet owners often enjoy having the pet at large within the vehicle interior.

Many owners of smaller dogs in particular enjoy sitting within the vehicle having the dog positioned on the owners lap in a position in which the dog is able to look or extend outwardly through the window. Smaller dogs often position themselves on their owner's lap standing upward on their rear paws and resting their front paws upon the door shelf of the vehicle door beneath the side window. This position allows the dog to see out of the window and in some instances extend all or part of their head outwardly should the window be open. In addition, many dogs seem to enjoy moving back and forth along the door shelf to better view the passing scene or better extend their heads outwardly through an open window.

Unfortunately, as much as pet owners and dogs or other pets seem to enjoy this activity, certain problem areas arise for both the pets and their owners in connection with this practice. For example, the typical interior door shelf of a vehicle beneath the window is formed in a slope or rounded and downwardly curved configuration. This type of surface does not usually prove to be a good area for the pet to stand or partially support itself as the vehicle moves and various momentum forces are applied to the dog. In addition, the typical door panel interior of a vehicle is upholstered to obtain certain aesthetic and comfort benefit for the vehicle users. Thus, attempts by dogs or other pets to maintain their paw positions upon the door panel shelf may result in scratching or other damage to the surface of the upholstered interior panel. Finally, the upholstery or surface material typically utilized in vehicle door shelf panels is usually fabricated using a smooth slippery material such as paint, vinyl, leather or smooth cloth upholstery. As a result, dogs attempting to maintain their paws on the door shelf find themselves slipping and in many instances falling as the vehicle moves and stops.

Despite the problems described above, pet owners seem determined to enjoy the activities of having their pets within their vehicles as they move about. As a result, there remains a need in the art for an effective apparatus which facilitates this practice of holding and supporting a pet such as a dog and allowing the pet stand wholly or partially upon the door shelf of the vehicle interior.

### SUMMARY OF THE INVENTION

Accordingly, it is a general object of the present invention to provide apparatus which enhances the experience of pet owners and pets in traveling vehicles. It is a more particular object of the present invention to provide apparatus which provides a convenient surface for a dog such as a pet to stand or partially stand while gazing out or extending through a vehicle window. It is a still more particular object of the present invention to provide apparatus which protects the surface of the door interior shelf due to pet activities.

In accordance with the present invention, there is provided for use in a vehicle having a vehicle door or other area defining a window gap, a window within the gap, and an interior door shelf, a pet shelf comprising: a support plate receivable within a vehicle door through its window gap; a support surface joined to the support plate in a generally perpendicular attachment; and a surface cover attached to the support surface.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a partial perspective of a typical vehicle interior and a seated vehicle driver having a standing dog gazing out the vehicle window together with a pet shelf for vehicles constructed in accordance with the present invention;

FIG. 2 sets forth a partial section view of the present invention pet shelf and vehicle interior taken along section lines 2-2 in FIG. 1;

FIG. 3 sets forth a perspective view of a pet shelf for vehicles constructed in accordance with the present invention showing a partial attachment of the shelf covering material;

FIG. 4 sets forth a perspective view of an alternate embodiment of the present invention shelf for vehicles showing a partial attachment of an alternative surface material;

FIG. 5 sets forth a perspective view of a still further alternate embodiment of the present invention having a still further variation of surface covering material;

FIG. 6 sets forth a side elevation view of the present invention pet shelf for vehicles;

FIG. 7 sets forth a perspective view of a still further alternate embodiment of the present invention pet shelf for vehicles;

FIG. 8 sets forth a partial section view of a vehicle door having the embodiment of the present invention shown in FIG. 7 secured thereto; and

FIG. 9 sets forth a partial perspective view of the present invention pet shelf utilized in the rear passenger area of a typical host vehicle.

### DESCRIPTION OF THE PREFERRED EMBODIMENTS OF THE INVENTION

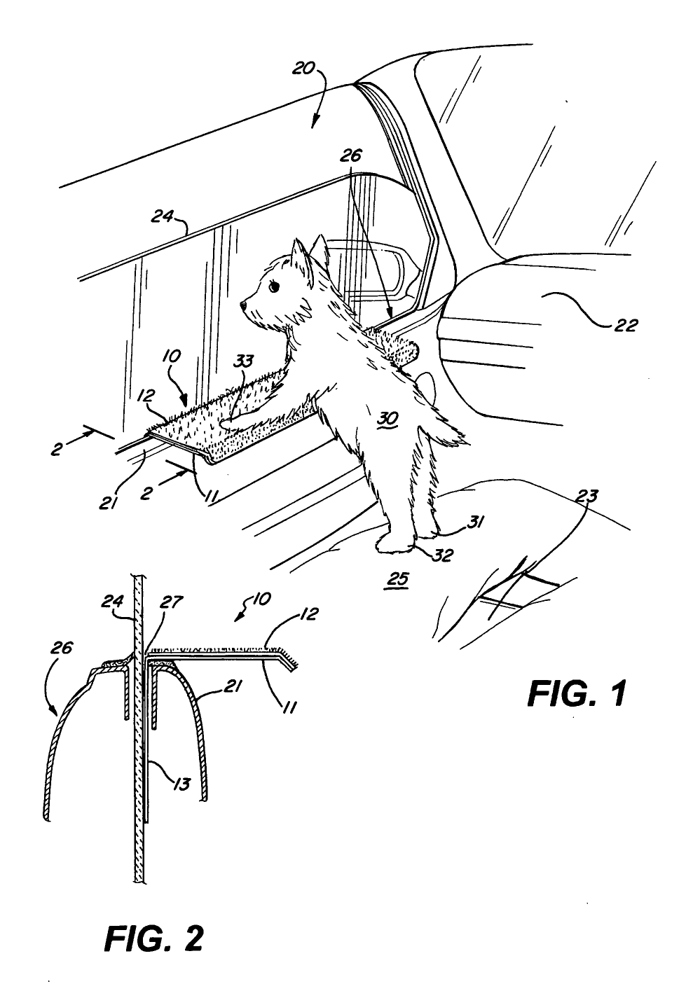

FIG. 1 sets forth a partial perspective view of the interior of typical vehicle such as an automobile generally referenced by numeral 20. In accordance with conventional fabrication techniques, vehicle interior 20 includes a vehicle dashboard 22, a front seat 23 and a front door 26. In further accordance with conventional fabrication techniques, front door 26 supports a side window 24 and further includes a door shelf 21. Vehicle interior 20 as well a door shelf 21, dashboard 22, front seat 23, side window 24 and door 26 are fabricated in accordance with conventional fabrication techniques.

In accordance with the present invention, a pet shelf generally referenced by numeral 10 is secured to door 26 in the manner better seen below in FIG. 2. Suffice it to note here that pet shelf 10 includes a support surface 11 extending inwardly from side window 24. In further accordance with the present invention, support surface 11 is covered by a surface cover 12. Support surface may be covered by a cushioned material, artificial turf, non-slip material or simply formed as desired in the fabrication process. In further accordance with the anticipated use of the present invention, a typical small dog 30 having rear paws 31 and 32 and front paws 33 and 34 (front paw 34 not seen) is shown standing upon pet owner 25 in an upright position supported by paws 33 and 34 resting upon surface cover 12.

The position of dog 30 is typical of the positions assumed by small dogs or other pets in looking outwardly through side window 24. It will be apparent to those skilled in the art that small dog 30 is merely illustrative and that the present invention applies equally well to larger dogs and/or other pets such as cats etc. It will also be noted by examination of FIG. 1 that the front paws of dog 30 do not come in contact with door shelf 21 but instead contact solely upon surface cover 12. In this manner it will be apparent to those skilled in the art that the upholstery material typically used on door shelf 21 is protected from damage due to the front paws and the scratching action of the dogs nails (not shown). It will be further apparent to those skilled in the art by examination of FIG. 1 that pet shelf 10 provides a more desirable surface for supporting the front paws of dog 30 in that support surface 11 of pet shelf 10 extends substantially horizontally into vehicle interior 20. This provides a much more readily gripped and much more supporting surface for the front paws of dog 30. In addition, those skilled in the art will note that while FIG. 1 illustrates a typical position for dog 30 with respect to pet owner 25 and pet shelf 10, other animals may utilize pet shelf 10 in different postures without departing from the spirit and scope of the present invention. For example, extremely small animals such as kittens or small cats may find it desirable to rest entirely upon pet shelf 10 without resort to the stand up position shown by dog 30.

FIG. 2 sets forth a partial section view of door 26 and pet shelf 10 taken along section lines 2-2 in FIG. 1. As described above, door 26 is fabricated in accordance with conventional fabrication techniques and downwardly slopped door shelf 21 on the interior side thereof. In further accordance with conventional fabrication techniques, door 26 defines a gap 27 which receives side window 24. An operative mechanism (not shown) constructed in accordance with conventional fabrication techniques will be understood to operatively engage and support side window 24. In further accordance with conventional fabrication techniques, it will be understood that this mechanism will be operatively coupled to side window 24 to facilitate raising and lowering side window 24.

In accordance with the present invention, a pet shelf 10 includes a support surface 11 joined to a support plate 13 in the preferred fabrication of the invention, support surface 11 and support plate 13 are joined in a generally perpendicular arrangement. This arrangement allows support plate 13 to be received within gap 27 and extend downwardly along side window 24 while support surface 11 extends inwardly above door shelf 21 in a substantially horizontal position. A surface cover 12 is secured to support surface 11 in the manner described below in greater detail. Suffice it to note here that surface cover 12 is preferably formed of a soft protective material which may be readily gripped by the dogs front paws.

In accordance with the present invention, it will be noted by examination of FIG. 2 that the extension of support surface 11 inwardly above door shelf 21 protect door shelf 21 from contact with the pets front paws and thereby protects the material utilized on door shelf 21 from damage and provides an effective surface which the pet may utilize in standing or gripping in manner such as that shown for dog 30 in FIG. 1.

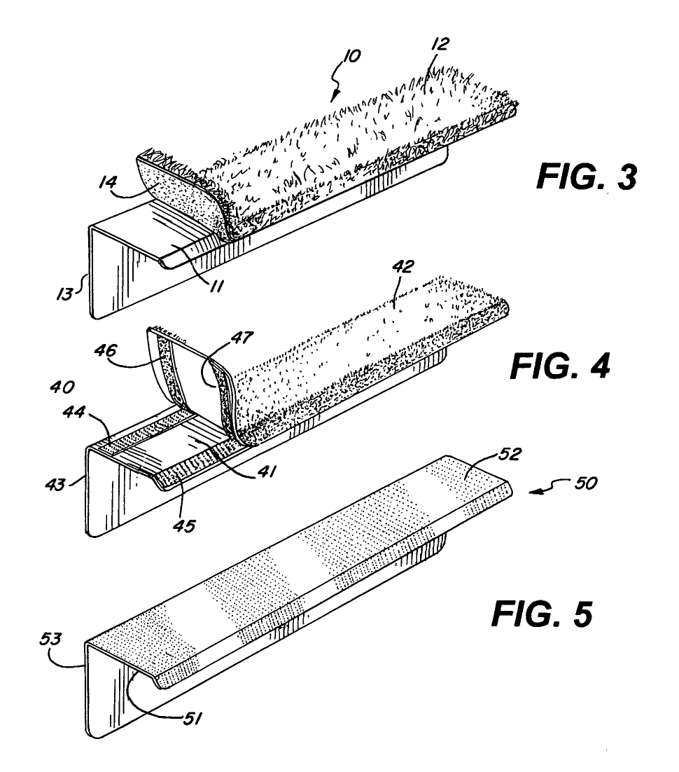

By way of overview, FIGS. 3, 4 and 5 show respective perspective views of alternate embodiments of the present invention pet shelf which are substantially identical to in structure but differ in the surface cover material and/or the attachment apparatus used in securing the surface cover in place. Thus, FIG. 3 shows an embodiment of the present invention utilizing a material such as synthetic turf or carpet while FIG. 3 shows the utilization of a very close nap fabric cover and finally FIG. 5 shows a surface cover which may be formed of a deposited material such as a sprayed adhesive or painted on gripping material such as plastic or rubberized paint.

More specifically, FIG. 3 sets forth a perspective view of pet shelf 10 having support surface 11 and support plate 13 joined in a right angle arrangement. Support surface 11 receives a support cover 12 formed of a material such as artificial turf, carpet or other similar material. Cover 12 is shown in FIG. 3 partially peeled back from support surface 11 to reveal an attachment coating adhesive 14. Thus, in the embodiment shown in FIG. 3, surface cover 12 is secured to support surface 11 by an adhesive. In its preferred form, adhesive 14 is a reusable adhesive of the type used in contact cement or the like to facilitate removing and replacing of surface cover 12 as the surface cover becomes soiled or worn. Alternatively, adhesive 14 may be a permanent attachment anticipating the user will simply replace the entire pet shelf when such wear or soiling surface cover 12 occurs.

FIG. 4 sets forth a perspective view of an alternate embodiment of the present invention pet shelf generally reference by numeral 40. As mentioned above, pet shelf 40 is substantially similar to pet shelf 10 with the exception being found in surface cover 42. Thus, pet shelf 40 includes a support surface 41 joined to a support plate 43. Surface cover 42 is formed of a woven or carpet-like material having a substantially shorter nap than surface cover 12 shown in FIG. 3. Additionally, an alternative mechanism for attachment of surface cover 42 is utilized. In the embodiment shown in FIG. 4, a pair of attachment pad material strips 44 and 45 are secured directly to support surface 41. A cooperating pair of attachment pad strips 46 and 47 are positioned on the underside surface cover 42. In their preferred fabrication, attachment pads 44, 45, 46 and 47 are formed of the popular hook and loop attachment pads which facilitate removable attachment of surface cover 42.

FIG. 5 sets forth a still further alternate embodiment of the present invention pet shelf generally referenced by numeral 50. As mentioned above, pet shelf 50 is substantially the same in structure as pet shelf 10 described above with surface cover 52 being the primary difference. Thus, pet shelf 50 includes support surface 51 and support plate 53 joined in a perpendicular attachment. A surface cover 52 is secured to support surface 51 to provide a non-skid protective surface for the paws of the pet resting upon pet shelf 50. Thus, support cover 52 may be fabricated using a spray plastic material or spray adhesive material or other corresponding materials sprayed or deposited upon support surface 51 to form surface cover 52.

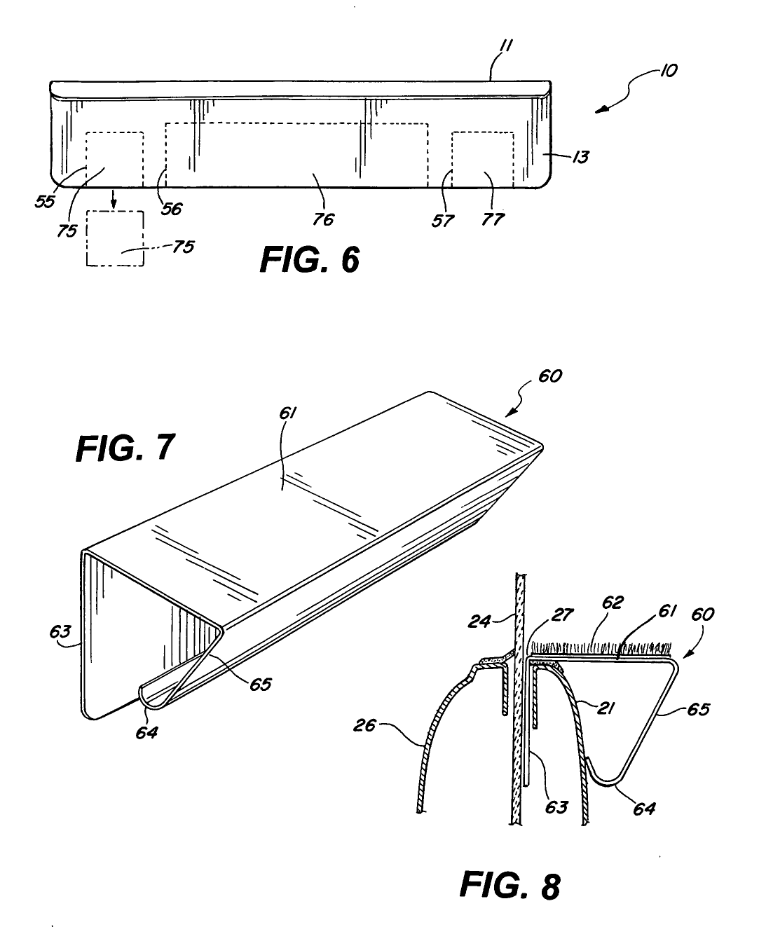

FIG. 6 sets forth a side elevation view of pet shelf 10 showing the further fabrication of support plate 13. As described above, pet shelf 10 includes a support surface 11 and a support plate 13 joined in a right angle relationship. In the embodiment of the present invention shown in FIG. 6, support plate 13 defines a plurality of serrated lines 55, 56 and 57 formed in support plate 13 to facilitate the selective removal of notch portions 75, 76 and 77. By way of example, removed notch portions 75 is shown in FIG. 6 in phantom line depiction indicating serration line 55 has been parted allowing the removal of notch portion 75. A similar operation may be carried forward on serrated line 56 to provide removal of notched portion 76 and serrated line 57 to allow removal of notch portion 77. In this manner, the structure of support plate 13 may be altered by removing one or more of notch portions 75, 76 and 77 to provide clearance notches in support plate 13. The function of such clearance notches is to provide clearance for movement of the operative mechanism within door 26 (not shown) which supports and moves side window 24. In the event such clearance is not required, serrated lines 55, 56 and 57 are left undisturbed maintaining the planar uninterrupted structure of support plate 13.

FIG. 7 sets forth a perspective view of a still further alternate embodiment of the present invention pet shelf generally referenced by numeral 60. Pet shelf 60 includes a support surface 61 and a support plate 63 joined in a right angle relationship. Pet shelf 60 further includes a downwardly and inwardly extending angled brace 65 which terminates along its bottom edge in an upwardly curved end 64.

FIG. 8 sets forth a partial section view of vehicle door 26 similar to that shown above in FIG. 2. By way of further similarity, FIG. 8 shows a section view of pet shelf 60 installed upon vehicle door 24. As described above, vehicle door 26 includes a downwardly curved door shelf 21 and a gap 27. In further accordance with the above-described structure, door 26 supports a side window 24 extending through gap 27.

In accordance with the present invention, pet shelf 60 is secured to door 26 by extending support plate 63 downwardly through gap 27. When so positioned, support plate 63 causes support surface 61 to extend inwardly above door shelf 21. A shelf cover 62 is received upon and secured to support surface 61 in accordance with the above described alternate embodiments. Pet shelf 60 further includes a downwardly and inwardly angled brace 65 which terminates at its lower end in a curved end 64. The function of angled brace 65 and curved end 64 provides additional support for surface 61 by placing curved end 64 against the surface of door shelf 21. In this manner, flexing of the right angle junction between support surface 61 and support plate 63 is prevented as the weight of the dog upon support surface 61 is partially supported by angled brace 65 and curved end 64 against door shelf 21.

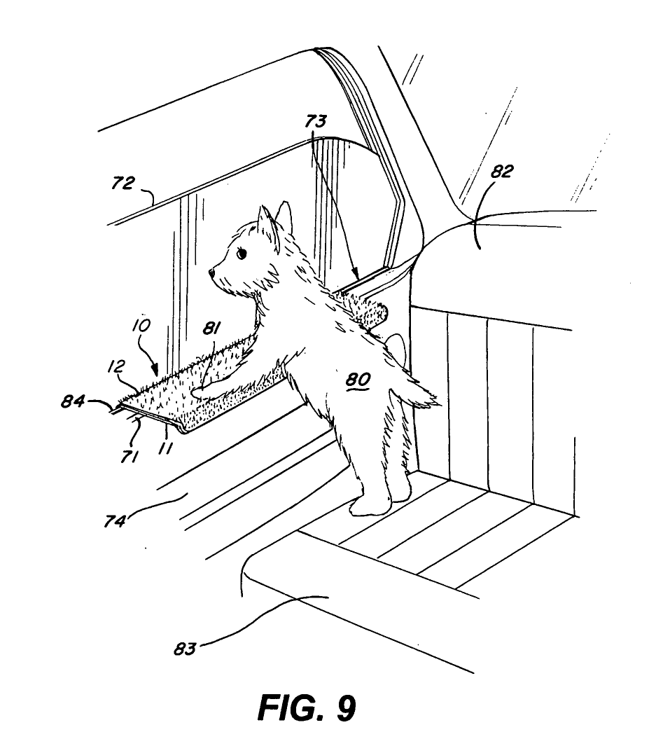

FIG. 9 sets forth a partial perspective view of a dog 80 utilizing present invention pet shelf 10 in the rear passenger area of a typical vehicle such as a car or truck. Thus, as described above, pet shelf 10 includes a support shelf 11 having shelf cover 12 secured thereto. Also, pet shelf 10 includes a support plate 13 (seen in FIG. 2). The host passenger environment shown in FIG. 9 is of typical construction and includes a rear door 73 having a door panel 74 defining a door shelf 71 and a window 72. A rear seat back 82 and rear seat 83 completes the rear passenger area. In further accordance with conventional construction, door 73 defines a gap 84 through which window 72 is raised and lowered from and into the interior of door 73. In a similar attachment to that shown in FIG. 2, support plate 13 extends through gap 84.

It should be noted that the present invention pet shelf is not limited to side windows but rather may be used in other environments such as the rear window of certain pickups or the panel windows and bed areas of pickups, panel trucks, camper trucks shells or pickup truck beds without departing from the present invention.

What has been shown is a novel and effective apparatus for use as a pet shelf in vehicles which facilitates the positioning of a pet such as a dog upon an owners lap with front paws resting upon the vehicle door. The pet shelf supports the dog's front paws and provides protection for both the dog and the door surface material or upholstery.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

1. For use in a vehicle having a vehicle interior and a vehicle door defining a window gap, a window within the gap having an interior window surface and an exterior window surface, and an interior door shelf, a pet shelf comprising:
a support plate receivable within a vehicle door through its window gap against said interior window surface;
a support surface rigidly joined to said support plate in a generally perpendicular attachment and extending into said vehicle interior, said support surface being free of any brace and supported above said interior door shelf in a generally horizontal position solely by said support plate against said interior window surface; and
a surface cover attached to said support surface.

2. The pet shelf set forth in claim 1 wherein said surface cover extends generally over said support surface and adheres thereto.

3. The pet shelf set forth in claim 2 wherein said surface cover includes a layer of fabric material and attachment means for adherence to said support surface.

4. The pet shelf set forth in claim 3 wherein said attachment means includes an adhesive.

5. The pet shelf set forth in claim 4 wherein said surface cover is formed of a synthetic turf material.

6. The pet shelf set forth in claim 5 wherein said adhesive provides a removable attachment to facilitate removal of said surface cover for replacement or cleaning.

7. The pet shelf set forth in claim 3 wherein said attachment means includes cooperating hook-and-loop fabric attachment pads disposed on said support surface and said surface cover.

8. The pet shelf set forth in claim 2 wherein said surface cover includes a layer deposit of elastic material.

9. The pet shelf set forth in claim 2 wherein said surface cover includes a layer of non-stick abrasive material.

10. For use in a vehicle having a vehicle door defining a window gap, a window within the gap and an interior door shelf, a pet shelf comprising:
a support plate receivable within a vehicle door through its window gap;
a support surface joined to said support plate in a generally perpendicular attachment; and
a surface cover attached to said support surface,
wherein said support plate defines at least one removable clearance notch portion.

11. (canceled)

12. (canceled)

13. A method of protecting a vehicle shelf from pet damage and for providing a pet supporting surface within a vehicle interior having a door defining an interior door shelf, a window gap and a window within said gap having an interior window surface and an exterior window surface, said method comprising the steps of:
providing a generally planar support surface and support plate rigidly joined in a generally perpendicular relationship;
inserting said support plate into said window gap to extend downwardly therethrough against said interior window surface and support said surface above said interior door shelf to extend inwardly from a said vehicle window entirely supported by said support plate against said interior window surface in a generally horizontal position;
providing an upper surface upon said support surface for a pet's paws to engage or rest upon.

14. The method set forth in claim 13 wherein said providing step includes the step of providing a non-slip surface upon said support surface.

15. The method set forth in claim 13 wherein said providing step includes the step of providing a cushioned surface upon said support surface.

16. The method set forth in claim 13 wherein said providing step includes the step of providing an artificial turf surface upon said support surface.

17. The method set forth in claim 13 wherein said providing step includes the step of providing a removable cover upon said support surface.
